(19) United States
(12) Patent Application Publication
(10) Pub. No.: US 2026/0366596 A1
(43) Pub. Date: Nov. 19, 2026

(54) SYNCHRONOUS TRANSMISSION BELT AND AN ASSEMBLY COMPRISING THIS BELT AND AN ASSOCIATED PULLEY

(71) Applicant: HUTCHINSON, PARIS (FR)

(72) Inventor: Hervé VARIN, SAVONNIERES (FR)

(21) Appl. No.: 19/135,517

(22) PCT Filed: Dec. 7, 2023
(86) PCT No.: PCT/EP2023/084731

§ 371 Date: Jun. 4, 2025

(30) Foreign Application Priority Data
Dec. 8, 2022 (FR) FR2212989

(51) Int. Cl. F16G 1/28; B29D 29/08; B29K 105/10; F16H 7/02

(52) U.S. Cl. CPC F16G 1/28; B29D 29/08; F16H 7/023; B29K 2023/04; B29K 2105/106

(57) ABSTRACT

A synchronous transmission belt having an elastomer-based body comprising a dorsal portion, a ventral portion and a set of traction cords between the dorsal portion and the ventral portion is disclosed. The ventral portion has a plurality of transverse teeth, each transverse tooth having in cross section a first profile with two inclined flanks connected by at least one rounded portion, each transverse tooth having a tooth height H1, and a plurality of longitudinal teeth. Each longitudinal tooth extends between two transverse teeth substantially perpendicularly to said transverse teeth and having in cross section a second profile with two inclined flanks connected by at least one rounded portion, each longitudinal tooth having a non-zero tooth height H2, which is less than or equal to the tooth height H1.

### TECHNICAL FIELD OF THE INVENTION

The present invention relates to a synchronous transmission belt. The invention also relates to an assembly comprising the belt and at least one associated pulley. The invention also relates to a method for manufacturing such a belt.

### TECHNICAL BACKGROUND

In general, power transmission by belt is widespread and covers a wide range of applications, such as the automotive sector, conveying objects, or transmission for velocipedes (commonly referred to as bicycles).

Some applications require the transmission of very high torques. Not all types of belt, e.g. poly-V® type, i.e. ridged in the longitudinal direction of the belt, necessarily have the level of performance required for such applications. Synchronous systems are preferred, i.e. a synchronous belt with transverse teeth and corresponding pulleys. This is particularly the case for bicycle applications.

However, these synchronous transmission systems require the axes of rotation to be perfectly parallel and the pulleys to be properly aligned. Otherwise, there is a risk of the belt moving laterally on the pulleys, leading to damage and/or the belt coming off the latter.

To avoid these lateral movements, it may be useful for the transmission system to comprise a guide means. Some solutions involve placing flasks to the pulley on either side of the belt. However, the belt tends to rub against these elements, which accelerates wear and prevents foreign elements such as water or gravel from being evacuated.

Other solutions propose a central machining in the tooth of the synchronous belt, thus defining a groove which will come to rest on a corresponding web of material placed in the center of the pulley with which the belt co-operates. This is for example what is proposed in the document EP-B1-3 478 561.

However, this principle is restrictive in terms of the design of the pulleys and the machining of the teeth of the belt. In addition, the groove created on the belt by this machining may be damaged by the insertion of foreign bodies during operation. These foreign bodies may, for example, be mud or gravel when such a system is used for a bicycle application.

Other solutions offer a negative of the first solution, i.e. in addition to the synchronous teeth, the belt comprises at least one web that engages in a groove provided in the corresponding pulley. This configuration is proposed in particular in the documents WO-A1-2021/180678.

Also, the documents EP-B1-3 478 561 and WO-A1-2021/180678 each propose a synchronous belt whose transverse teeth each have a rounded summit, in particular with an overall arcuate profile. The web, whether positive (on the pulley) or negative (on the belt), only acts as a lateral block for the belt.

The document CN-U-208 651 535 proposes a synchronous belt whose transverse teeth each have a right trapezoidal profile. This document also proposes a V-shaped longitudinal tooth between each transverse tooth.

Generally speaking, to maximize the transmission of the torque between two pulleys, the belt must rest on the pulley with as large a contact surface as possible, while limiting the mechanical stresses associated, in particular, with the belt winding and the shape of the teeth.

The effect of such stresses is to accentuate the deformation of the teeth of the belt and even cause cracks to appear, particularly at the tooth root, thereby accelerating the degradation of the belt.

A further objective of the invention is to provide a synchronous transmission belt that does not have at least one of the aforementioned disadvantages.

Another aim of the invention is to offer a synchronous transmission belt with improved performance in terms of the torque that may be transmitted between two pulleys.

### SUMMARY OF THE INVENTION

A synchronous transmission belt is therefore proposed comprising an elastomer-based body comprising a dorsal portion, a ventral portion and an assembly of tensile cords between the dorsal portion and the ventral portion, the ventral portion having, on the one hand, a plurality of transverse teeth, each transverse tooth having in cross-section a first profile with two inclined flanks converging towards each other in the direction of a summit of the transverse tooth, the flanks of the transverse tooth being connected by at least one rounded part, each transverse tooth having a tooth height H1, and, on the other hand, a plurality of longitudinal teeth, each longitudinal tooth extending between two transverse teeth substantially perpendicular to the transverse teeth and having in cross-section a second profile with two inclined flanks converging towards each other in the direction of a summit of the longitudinal tooth, the flanks of the longitudinal tooth being connected by at least one rounded part, each longitudinal tooth having a tooth height H2, this non-zero height H2 being less than or equal to the tooth height H1.

The invention thus ensures an improvement in the torque transmissible by the belt and its stability. In fact, in use, the contact surface between the belt and the pulley configured to receive it is high thanks to the profiles of the teeth, and in particular thanks to the longitudinal teeth which not only have the function of guiding the belt on the pulley but also, with the shape of their profile, participate the transmission of the torque, together with the transverse teeth. The presence of cords improves the tensile modulus of the belt, so the transmissible torque may be controlled.

The belt, according to the invention, may comprise one or more of the characteristics below, taken in isolation from each other or in combination with each other:
the non-zero tooth height H2 of each longitudinal tooth is strictly less than the tooth height H1 of each transverse tooth,
the tooth height H2 of each longitudinal tooth is such that 0.4×H1≤H2≤0.8×H1,
each transverse tooth has in cross-section a trapezoidal profile with rounded angles,
the first profile of each transverse tooth comprises two convex summit portions, these convex summit portions being located on either side of a summit portion, and two concave portions, said concave portions being located on either side of a base of the transverse tooth,
each convex summit portion of the first profile has an approximate radius of curvature of between 0.6 mm and 1.4 mm, and each concave portion has a radius of curvature of between 0.6 mm and 1.4 mm,
the second profile of each longitudinal tooth comprises two concave portions, these concave portions being located on either side of a base of the longitudinal tooth, and a tooth summit, said summit being convex,
-each concave portion of the second profile has a radius of curvature of between 0.8 mm and 1.6 mm, and said summit of the second profile has a radius of curvature of between 0.8 mm and 1.6 mm,
the second profile of each longitudinal tooth is a trapezoidal profile with rounded angles,
the synchronous transmission belt comprises a coating arranged at the level of an external surface of the plurality of transverse and longitudinal teeth,
the elastomer-based body of belt is made of a material chosen from ethylene-alpha-olefin or polyurethane, and the coating is a textile material or an elastomer thermoplastic film,
each cord of the assembly of the tensile cords is made of aramid, polyester, glass fiber or carbon fiber or a combination thereof,
the transverse teeth are distributed with a pitch of 11 mm.

The invention also relates to an assembly comprising at least one pulley and a synchronous transmission belt as described above, each pulley comprising:
two circumferential rows of toothing parallel to each other and configured to receive the tooth recesses of the plurality of transverse teeth of the belt, and
a circumferential groove, separating the two circumferential rows of toothing, configured to receive the plurality of longitudinal teeth of the belt.

The assembly, according to the invention, may comprise one or more of the characteristics below, taken alone with each other or in combination with each other:
the assembly comprises a first pulley of a given size and a second pulley of a different size to the first pulley,
the assembly comprises a first pulley and a second pulley which are identical,
each circumferential row of toothing comprises tooth recesses having a depth P1 greater than a height H1 of the transverse teeth of the belt,
the longitudinal groove has a depth P2 greater than a height H2 of the longitudinal teeth of the belt,
each pulley is made of a material selected from steel, aluminum or plastic.

The invention also relates to a method for manufacturing a synchronous transmission belt as described above, the method comprising the following steps:
forming a belt blank from belt materials around a cylindrical mandrel;
removing the blank from the mandrel;
inserting the blank inside a cylindrical mold comprising on an internal cylindrical wall a negative pattern of transverse and longitudinal teeth to be formed on a belt;
pressing the blank against the mold by means of an inflatable rubber bladder, and heating the mold so as to vulcanize the belt blank;
unmolding the vulcanized blank; and
cutting the vulcanized blank so as to form the belt.

### BRIEF DESCRIPTION OF THE FIGURES

The invention will be better understood with the aid of the following description, given only by way of example and made with reference to the attached drawings wherein:

FIG. 1 shows a partial schematic perspective view of a belt according to the invention,

FIG. 2 shows a schematic profile view of the belt shown in FIG. 1,

FIG. 3 shows a schematic profile view of another embodiment of a synchronous transmission belt according to the invention,

FIG. 4 shows a schematic cross-sectional view of the belt in FIG. 1,

FIG. 5 shows a schematic cross-sectional view of another embodiment of the synchronous transmission belt according to the invention,

FIG. 6 shows a schematic view of a step in a method for manufacturing a belt according to the invention, in particular the positioning of a belt blank in a mold,

FIG. 7 shows a schematic view in longitudinal cross-section of a detail of the step of the method in FIG. 6,

FIG. 8 shows a schematic view of another step in the method for manufacturing a belt according to the invention, in particular the positioning of an inflatable bladder inside the blank,

FIG. 9 shows a schematic view in longitudinal cross-section of a detail of the step of the method in FIG. 8,

FIG. 10 shows a schematic view of another step in the method for manufacturing a belt according to the invention, in particular the printing of the mold pattern on the blank,

FIG. 11 shows a schematic view in longitudinal cross-section of a detail of the step of the method in FIG. 10,

FIG. 12 shows a schematic view of another step in the method for manufacturing a belt according to the invention, in particular the removal of the molded blank,

FIG. 13 shows a schematic view of a tensile strength test of the belt according to the invention,

FIG. 14 shows a schematic perspective view of an assembly according to the invention comprising at least one pulley and a synchronous transmission belt,

FIG. 15 shows a schematic side view of the assembly shown in FIG. 14, and

FIG. 16 shows a schematic cross-sectional view of the assembly shown in FIG. 14.

### DETAILED DESCRIPTION OF THE INVENTION

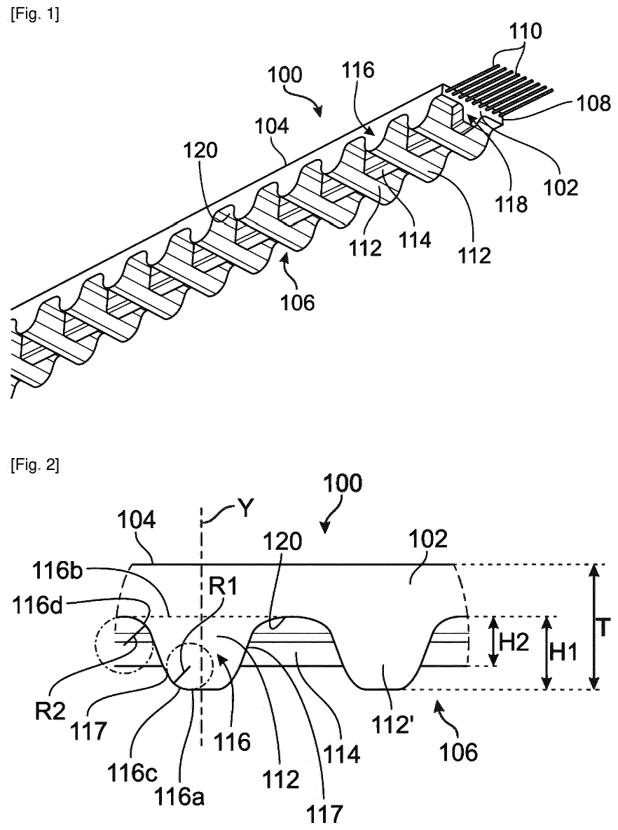

FIG. 1 shows a perspective view of an embodiment of a synchronous transmission belt 100 according to the invention.

The synchronous transmission belt 100 comprises an elastomer-based body 102 and an assembly of tensile cords 110.

The elastomer-based body 102 comprises a dorsal portion 104. This elastomer-based body 102 also comprises a ventral portion 106, formed of a plurality of teeth 112, 112′, 114, 114′. This plurality of teeth 112, 112′, 114, 114′ comprises on the one hand a plurality of transverse teeth 112, 112′ and on the other hand a plurality of longitudinal teeth 114, 114′. The plurality of transverse teeth 112, 112′ and the plurality of longitudinal teeth 114, 114′ each comprise an external surface configured to cooperate, at least in part, with a tooth recess of a pulley.

Each transverse tooth 112, 112′ also has, in cross-section, a first profile 116 with two inclined flanks 117 converging towards each other in the direction of the summit of the tooth, these two flanks 117 also being connected by at least one rounded part at the level of the summit.

“Rounded” means that the first profile 116 of the transverse teeth 112, 112′ has a shape defining at least one curvature.

In one embodiment, illustrated in FIGS. 2 to 4, this first profile 116 may be trapezoidal with rounded angles.

“Trapezoidal” is understood to mean that the first profile 116 of the transverse teeth 112, 112′ has a trapezoidal shape, i.e. a deformed trapezoid, or trapezoid. Thus, the summit of each transverse tooth 112, 112′ defines a summit portion 116a, of non-zero dimension, parallel or not to an imaginary base 116b of the transverse tooth 112, 112′ (represented by a broken line in FIG. 2), itself parallel to the dorsal portion 104 of the belt 100. In other words, the summit of each transverse tooth 112, 112′ defines a summit portion 116a, of non-zero dimension, parallel or not to the dorsal portion 104 of the belt 100. It is understood that the dorsal portion 104 of the belt 100 is substantially flat and that the summit portion 116a is also substantially flat.

“Rounded angles” are understood to mean that the first profile 116 of the transverse teeth 112, 112′ comprises, on the one hand, at least one angle describing a convex curvature at the level of the summit of the transverse tooth 112, 112′, referred to as the convex summit portion 116c, and/or, on the other hand, at least one angle describing a concave curvature at the level of the tooth recess 120, referred to as the concave portion 116d.

In other words, the first profile 116 of the transverse teeth 112, 112′ advantageously comprises a substantially flat summit portion 116a of teeth, at least one convex summit portion 116c and at least one concave portion 116d of bottom tooth recess 120.

Typically, the summit portion 116a of the transverse teeth 112, 112′ may have a non-zero dimension of between 3 mm and 6 mm.

Typically, the convex summit portion 116c is the result of a cubic spline of several points, or nodes, of the first profile 116. In this way, an equal convexity on either side of each point is defined. An approximate radius of curvature R1 may also be determined for this convex summit portion 116c.

Typically, the convex summit portion 116c has an approximate radius of curvature R1 that may be between 0.6 mm and 1.4 mm.

The concavity of the concave portion 116d is directly dependent on the spline obtained and described above. In other words, the radius of curvature R2 of the concave portion 116d depends on this spline.

Typically, the radius of curvature R2 of the concave portion 116d may be between 0.6 mm and 1.4 mm.

Each transverse tooth 112, 112′ having an axis of symmetry Y, it is understood that the first profile 116 of each transverse tooth 112, 112′ comprises, when it is trapezoidal with rounded angles, two convex summit portions 116c, situated on either side of the summit portion 116a, and two concave portions 116d, situated on either side of the base 116b.

In one embodiment, the first profile 116 of each transverse tooth 112, 112′ may be defined as the component of a segment between two points, a radius bitangent between this segment and the base 116b of the tooth, in other words a concave portion 116d, and a spline tangent both to the segment and to a straight line tangent to the summit of the transverse tooth 112, 112′.

In use, this type of profile allows a higher torque to be transmitted by the belt 100, but may lead to a reduction in the quality of meshing. This also allows to reduce the stress on the transverse tooth 112, 112′ and its deformation.

Each longitudinal tooth 114, 114′ of the plurality of longitudinal teeth 114, 114′ also extends between two transverse teeth 112, 112′, substantially perpendicular to these transverse teeth 112, 112′. The belt 100 therefore has crossed teeth. Furthermore, within the width of the belt 100, a single longitudinal tooth 114, 114′ advantageously extends between two transverse teeth 112, 112′.

Each longitudinal tooth 114, 114′ also has, in cross-section, a second profile 118 with two inclined flanks 119 converging towards each other in the direction of the summit of the tooth, these two flanks 119 also being connected by at least one rounded part at the level of the summit. Taken together, the flanks 119 may be generally V-shaped or U-shaped, for example.

As previously, “rounded” is understood to mean that the second profile 118 of the longitudinal teeth 114, 114′ has a shape defining at least one curvature.

The second profile 118 of each longitudinal tooth 114, 114′ may have a summit defining a summit portion 118a of zero dimension. In this case, the summit of the longitudinal tooth 114, 114′ is convex and describes a circular arc.

In this case, the second profile 118 of the longitudinal teeth 114, 114′ advantageously comprises at least one concave portion 118d of bottom tooth recess 120 and a convex tooth summit 118c.

Typically, the concave portion 118d of bottom tooth recess 120 has a radius of curvature R2′ of between 0.8 mm and 1.6 mm.

Typically, the convex tooth summit 118c has a radius of curvature R3 of between 0.8 mm and 1.6 mm.

Each longitudinal tooth 114, 114′ has an axis of symmetry. It is therefore understood that the second profile 118 of each longitudinal tooth 114, 114′ comprises two concave portions 118d, located on either side of the base 118b and a convex tooth summit 118c.

Alternatively, not shown, the second profile 118 of each longitudinal tooth 114, 114′ may be trapezoidal with rounded angles, i.e. substantially similar to the first profile 116, described above. In such a case, the summit of each longitudinal tooth 114, 114′ defines a summit portion 118a, of non-zero dimension, parallel or not to an imaginary base 118b of the longitudinal tooth 114, 114′, itself parallel to the dorsal portion 104 of the belt 100. In other words, the summit of each longitudinal tooth 114, 114′ defines a summit portion 118a, of non-zero dimension, parallel or not to the dorsal portion 104 of the belt 100. It is understood that the dorsal portion 104 of the belt 100 is substantially flat and that the summit portion 118a is also substantially flat. Whereas the at least one curvature is defined, on the one hand, by at least one angle describing a curvature in a convex manner at the level of the summit of the longitudinal tooth 114, 114′, and/or, on the other hand, at least one angle describing a curvature in a concave manner at the level of the tooth recess 120. As the second profile 118 of the longitudinal tooth 114, 114′ has an axis of symmetry Y′, it is understood that the second profile 118 of each longitudinal tooth 114, 114′ comprises two convex summit portions, located on either side of the summit portion 118a, and two concave portions 118d, located on either side of the base 118b.

In addition, the inclined flanks 119 of each longitudinal tooth 114, 114′, connected by the rounding, form an angle between them the angle of which is between 30° and 50°. Advantageously, the value of this angle is between 30° and 45°, and preferably between 35° and 45°.

In addition, the transverse teeth 112, 112′ have a tooth height H1 and the longitudinal teeth 114, 114′ have a tooth height H2. The non-zero tooth height H2 of the longitudinal teeth 114, 114′ is less than or equal to the tooth height H1 of the transverse teeth 112, 112′.

Advantageously, the non-zero tooth height H2 of the longitudinal teeth 114, 114′ is strictly less than the tooth height H1 of the transverse teeth 112, 112′.

A lower tooth height H2 of the longitudinal teeth 114, 114′ than a tooth height H1 of the transverse teeth improves the flexural flexibility of the belt 100. An improved flexibility makes it easier to wind the belt 100 onto pulleys with a small diameter. The latter characteristic is particularly applications, for

Typically, the tooth height H1 of the transverse teeth 112, 112′ may be between 2.5 mm and 5 mm.

Typically, the tooth height H2 of the longitudinal teeth 114, 114′, when strictly less than the tooth height H1 of the transverse teeth 112, 112′, may be such that 0.4×H1≤H2<1.0×H1. Advantageously, the tooth height H2 is such that 0.4×H1≤H2≤0.9×H1, even more advantageously such that 0.4×H1≤H2≤0.8×H1, and preferably such that 0.5×H1≤H2≤0.8×H1.

It has also been observed that with a tooth height H2 greater than or equal to 0.4×H1, a good lateral guidance of the belt is improved, whereas with a tooth height H2 less than or equal to 0.8×H1, a good winding of the belt on a pulley is ensured.

In use, the transverse teeth 112, 112′ serve to transmit torque, and this torque transmission is all the greater due to the presence of inclined flanks 117 connected to each other by at least one rounded part. The longitudinal teeth 114, 114′ also transmit torque in addition to self-centering the belt 100. The angle formed by the flanks 119 introduced by the profile 118 of the longitudinal tooth 114, 114′, as previously described, contributes to the torque transmission. In addition, the rounded shape of the profile 118 allows the belt 100, in the event of its lateral displacement, to self-center more quickly on the pulley on which it is configured to be mounted, improving its guidance. The presence of longitudinal teeth 114, 114′ also limits the deformation of transverse teeth 112, 112′. Both torque transmission and guidance are improved by the fact that the tooth height H2 of the longitudinal tooth 114, 114′ is less than or equal to the tooth height H1 of the transverse tooth 112, 112′. If the tooth height H2 is greater than the tooth height H1, constraints may arise, in particular a reduction in the flexibility of the belt 100 and a mismatch with the pulleys on which the belt 100 is configured to cooperate.

The transverse teeth 112, 112′ of the belt 100 may be distributed with a pitch of 8 mm, 11 mm or 14 mm. Advantageously, the transverse teeth 112, 112′ of the belt 100 are distributed with a pitch of 11 mm.

The belt 100 also comprises an assembly of tensile cords 110. The cords 110 are embedded in the body 102 between the dorsal portion 104 and the ventral portion 106 of the body 102. The cords 110 increase the tensile modulus of the belt 100. They therefore extend along the length of the belt and are arranged next to each other across the width of the body 102. In particular, a cord 110 of the cord assembly may be made of a material selected from aramid, polyester, glass fibers or carbon fibers, or a combination thereof. For the application in question, they therefore allow a greater torque transmission while maintaining a very limited elongation of the belt 100.

The construction of each cord 110, the number of cords 110 arranged across the width of the belt 100 and the choice of the material making them up is variable and depends on the tensile modulus required for the belt 100 to ensure a torque transmission while limiting the elongation of the belt 100. The general effect of such cords 110 is to allow a higher torque transmission.

Advantageously, the tensile modulus of the belt 100 is chosen between 10,000 N/mm belt width (Newton per millimeter belt width) and 30,000 N/mm belt width, measured linearly between 0 and 1% elongation of the belt.

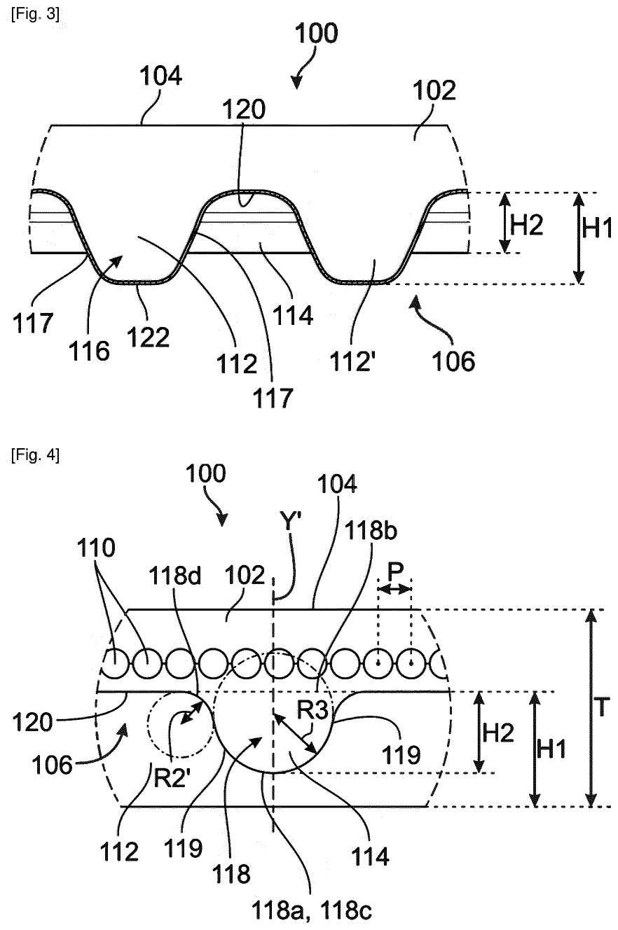

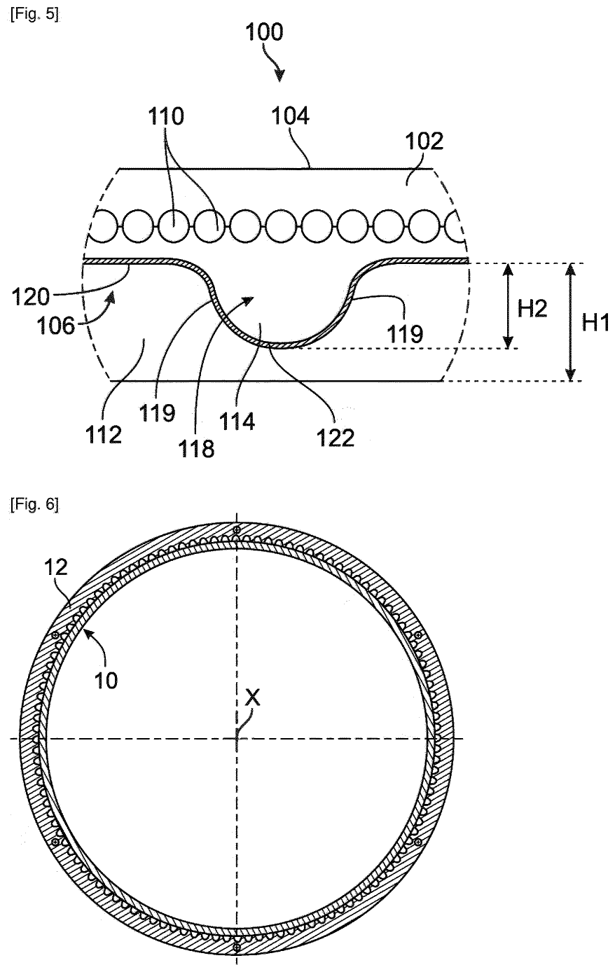

The synchronous transmission belt 100 may also comprise a coating 122 arranged at the level of the external surface of the plurality of teeth 112, 112′, 114, 114′, as shown in FIGS. 3 and 5. The coating 122 is of particular interest for reinforcing the tooth foot, i.e. the concave portions 116d, 118d of the transverse teeth 112, 112′ and the longitudinal teeth 114, 114′.

The coating 122 may typically be made of a textile material chosen, without limitation, from a knitted fabric, a woven fabric or a non-woven fabric. In this case, the coating 122 may be made of a material typically chosen from a polyamide (PA) or a polyamide-elastane blend.

Alternatively, the coating 122 may be an elastomeric thermoplastic film having a polymer matrix which is the combination of a thermoplastic matrix and an elastomeric matrix. The elastomeric part of the elastomeric thermoplastic is advantageously an ethylene-alpha-olefin such as ethylene-propylene-monomer (EPM) or ethylene-propylene-diene monomer (EPDM). The thermoplastic matrix of the elastomeric thermoplastic is advantageously an olefinic thermoplastic, for example low-density polyethylene.

This thermoplastic elastomer film may have a thickness of between 50 μm (micrometer) and 200 μm.

The elastomer-based body 102 of the belt 100 may be made of a material selected from, but not limited to, an ethylene-alpha-olefin such as ethylene-propylene-monomer (EPM) or ethylene-propylene-diene monomer (EPDM), a hydrogenated butadiene-acrylonitrile copolymer (HNBR) or polyurethane (PU).

Example of embodiment of a synchronous transmission belt according to the invention

In what follows, reference is made to FIGS. 2 to 5, which show a particular example of embodiment of the belt 100.

The elastomer-based body 102 is made of peroxide-cured ethylene propylene diene monomer (EPDM) with, in this example, a hardness of 85 Shore A.

In this example of embodiment, the belt 100 has a geometry defined as follows and illustrated in FIGS. 2 and 4. The body 102 has a thickness T of 6.5 mm, measured from the dorsal portion 104 to the summit of the transverse teeth 112, 112′, and a width of 12 mm.

Each transverse tooth 112, 112′ has a height H1 of 5 mm. Furthermore, in this example of embodiment, the first profile 116 of each transverse tooth 112, 112′ is trapezoidal with rounded angles. This first profile 116 has a summit portion 116a of 2 mm and a convex summit portion 116c with an approximate radius of curvature R1 of 1.2 mm.

Each longitudinal tooth 114, 114′ has a height H2 of 2.2 mm. In addition, the second rounded profile 118 of each longitudinal tooth 114, 114′ has a concave portion 118d of bottom tooth recess 120 with a radius of curvature R2′ of 1.2 mm and a convex tooth summit 118c with a radius of curvature R3 of 1.6 mm. In addition, the inclined flanks 119 connected by at least one rounded part of the second profile 118 of each longitudinal tooth 112, 112′ form an angle of 40° with each other.

The cord assembly 110 embedded in the body 102 comprises 13 cords 110. The cords 110 have a diameter d of 0.8 mm and their centers are separated laterally by a pitch p of 0.92 mm. The center of each cord 110 is also located at a distance of approximately 0.7 mm from the dorsal part 104 of the belt 100.

Each cord 110 is made of aramid, in particular 1100×1×4 aramid, i.e. each thread has a titer of 1100 dtex (decitex), i.e. 1100×10⁻⁷ kg/m (kilogram per meter), and each thread is first twisted individually before being twisted in fours. Each cord 110 also has a Young's modulus of 30000 MPa (Megapascal), or 30000 N/mm² (Newton per square millimeter).

The tensile modulus of the belt may thus be calculated and expressed as the Young's modulus of the cord 110 multiplied by the cross-sectional area of the cord 110. In the example of embodiment shown, the belt 100 has 13 cords 110, with the diameter d of each cord 110 being 0.8 mm, giving a total cross-sectional area of approximately 6.53 mm². This assembly of cords 110 thus allows to define the tensile modulus of the belt 100 at a value of approximately 195900 N.

In this example of embodiment, the transmission belt 100 comprises a coating 122, visible in FIGS. 3 and 5. This coating 122 is a polyamide knitted fabric, in particular polyamide 66 with a grammage of 150 g/m² (grams per square meter).

In this example of embodiment, the transverse teeth 112, 112′ of the belt 100 are distributed with a pitch of 11 mm. This pitch also has the advantage of optimizing the transmission of the torque and an overall dimension optimized. With a smaller pitch, less torque is transmitted, while with a larger pitch, the overall dimension of the teeth increases.

Reference is now made to FIGS. 6 to 12, which illustrate steps in the manufacture of a belt 100 in the above-mentioned embodiment.

The method for manufacturing a belt 100 according to the invention consists in:
forming a belt blank 10 from belt materials around a cylindrical mandrel;
removing the blank from the mandrel;
inserting the blank 10 inside a cylindrical mold 12 comprising, on an internal cylindrical wall, a negative pattern of transverse teeth 112, 112′ and longitudinal teeth 114, 114′ to be formed on the belt 100,
pressing the blank 10 against the mold 12 by means of an inflatable rubber bladder 14, and heating the mold 12 so as to vulcanize the belt blank 10;
unmolding the vulcanized blank; and
cutting the vulcanized blank 10 so as to form the synchronous transmission belt 100.

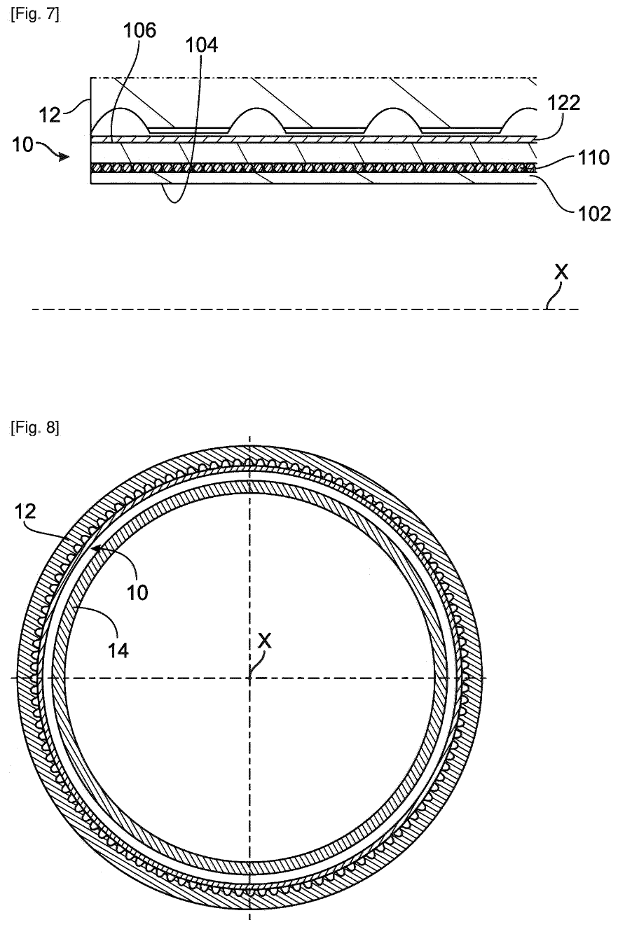

Beforehand, the belt materials that form the blank 10 are placed on a cylindrical mandrel (not shown). These belt materials comprise the dorsal portion 104 (in the raw state) of the belt body 102, the cords 110 and the ventral portion 106 (in the raw state) of the belt body 102. These belt materials may also comprise the coating 122, placed on the ventral portion 106 of the belt body 102. In FIGS. 6 and 7, the blank 10 has been removed from the cylindrical mandrel and is already inserted inside the cylindrical mold 12 which comprises on its internal cylindrical wall at least one pattern, negative to the profile of the transverse teeth 112, 112′ and the longitudinal teeth 114, 114′ to be formed on a belt. It is understood that the ventral portion 106 (in the raw state) is positioned in contact with the mold 12.

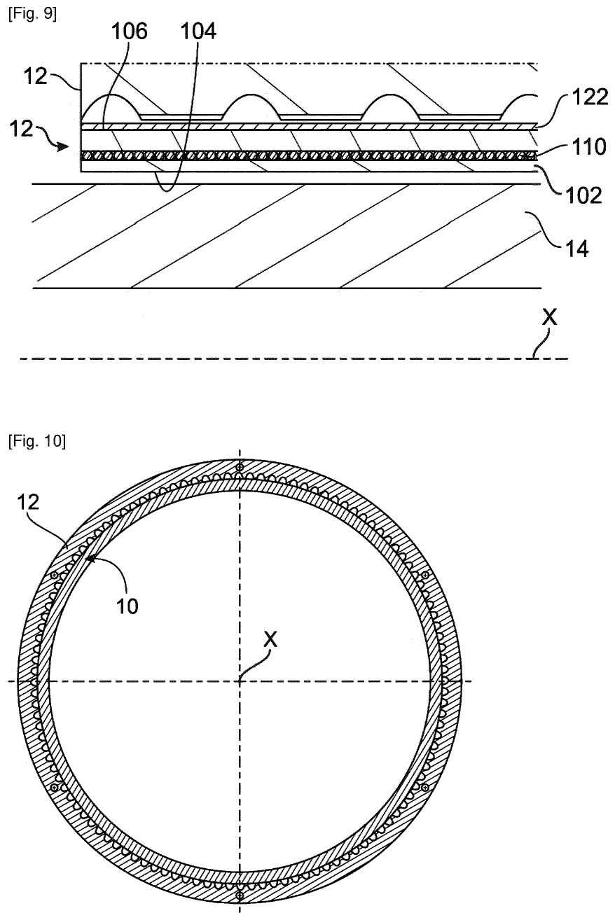

In FIGS. 8 and 9, the inflatable bladder 14 is positioned inside the blank 10.

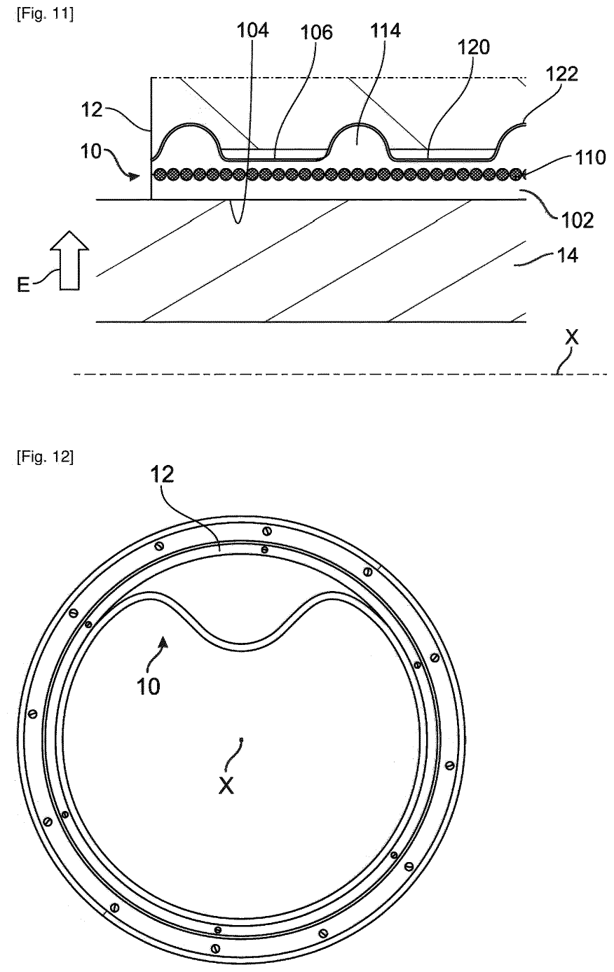

In FIGS. 10 and 11, the inflatable bladder 14 is inflated to a pressure of 20 bar so as to press the dorsal portion 104 (in the raw state) of the blank 10 against the mold 12 (see arrow E in FIG. 11). In this way, the internal wall of the mold 12 with at least one pattern, negative of the teeth 112, 112′, 114, 114′ to be formed on a belt, forms a corresponding pattern on the external surface of the ventral portion 106 of the blank 10. At the same time, the mold 12 is heated to 182 °C to ensure a vulcanization of the dorsal 104 and ventral 106 portions configured to form the vulcanized elastomer body 102. It is understood that the mold pattern 12 is printed on the blank 10 during this step.

The blank 10, which is now vulcanized, is then removed from the mold, as shown in FIG. 12, before being cut to the desired width to obtain a belt 100 according to the invention.

In the following, the tensile strength of the synchronous transmission belt 100 produced in this way was tested. The test performed with various standards, including ISO 4210-8 and the French and European standard NF EN 15194.

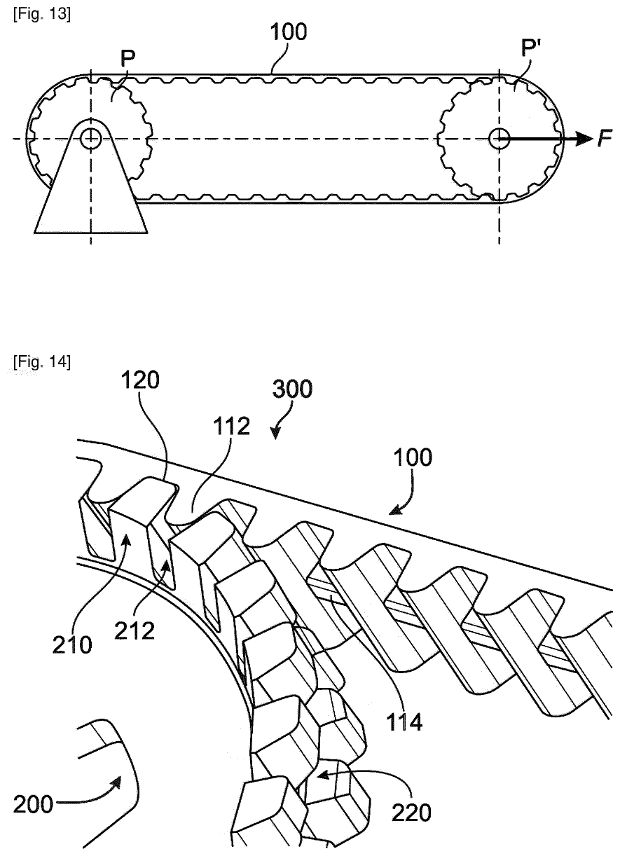

These standards describe the tensile strength test illustrated in FIG. 13. In this test, the belt 100 according to the invention is mounted on two similar or identical drive pulleys P, P′. At least one of the two pulleys P, P′ is free to rotate. During the test, the tensile load is gradually increased until the tensile force exerted on the belt 100 reaches 4000 N. For the force exerted on the belt 100 to reach 4000 N, a tensile load F of 8000 N is required.

When this threshold is reached, the belt 100 shows no cracks, breaks or delamination, in accordance with the recommendations of the standards.

End of the example.

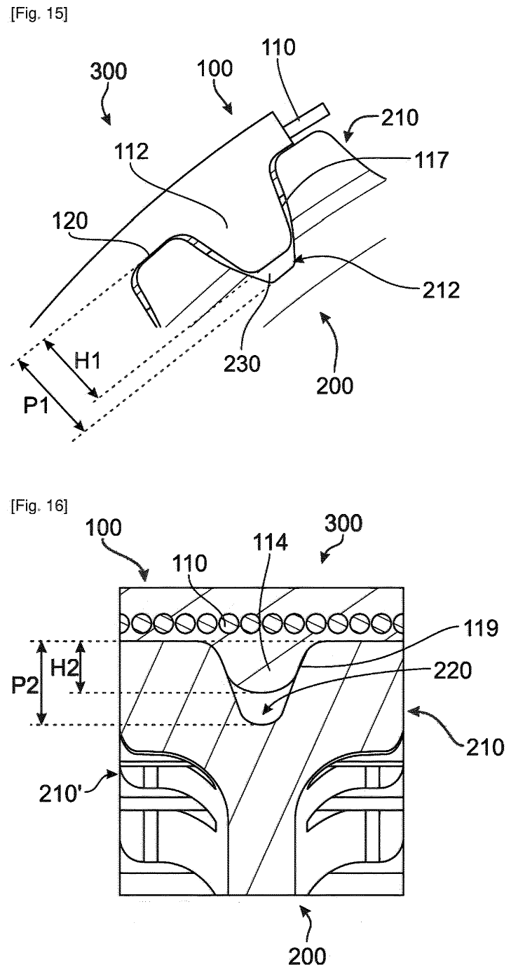

With reference to FIGS. 14 to 16, the invention also relates to an assembly 300 comprising a synchronous transmission belt 100 as described above and at least one pulley 200.

From a practical point of view, the assembly 300 may advantageously be presented in the form of a kit or already assembled.

Preferably, the belt 100 is configured to be mounted, in use, on two pulleys 200, i.e. a first pulley and a second pulley. Each of the pulleys 200 comprises, on the one hand, two circumferential rows of toothing 210, 210′ parallel to each other and configured to receive the tooth recesses 122 of the plurality of transverse teeth 112, 112′ of the belt 100 and comprises, on the other hand, a circumferential groove 220, separating the two circumferential rows of toothing 210, 210′, configured to receive the plurality of longitudinal teeth 114, 114′ of the belt 100.

Advantageously, the assembly 300 comprises a first pulley of a given size and a second pulley of a different size to the first pulley (not shown). A different size means a second pulley whose diameter is greater or smaller than the diameter of the first pulley.

Advantageously, the assembly 300 comprises a first pulley and a second pulley which are identical. Identical means two pulleys with the same dimensions, for example the same diameter and rows of toothing 210, 210′ with the same geometries.

Each pulley 200 may be made of a material chosen, but not limited to, steel, aluminum or plastic. Each of these materials has properties in terms of mechanical strength, density or cost that may be adapted to predefined applications.

Each circumferential row of toothing 210, 210′ also comprises tooth recesses 212 with a depth P1. Advantageously, this depth P1 is greater than the height H1 of the transverse teeth 112, 112′ of the belt 100.

The circumferential groove 220 in each pulley 200 also has a depth P2. Advantageously, this depth P2 is greater than the height H2 of the longitudinal teeth 144.

The toothing in each of the circumferential rows of toothing 210, 210′ may be distributed with a pitch of 8 mm, 11 mm or 14 mm.

It is therefore understood that there is a clearance 230 between the summit of each tooth 112, 112′, 114, 114′ and, on the one hand, the tooth recess 210 of the pulleys 200 and, on the other hand, the bottom of the groove 220. This clearance 230 has the advantage of being a means of evacuating foreign bodies, such as mud, water or stones, which may, during operation, be inserted into the assembly 300, and more particularly between a pulley 200 and the belt 100. As these foreign bodies are evacuated more easily, the risk of wear on the belt 100 is reduced.

In the light of what has been described above, it is clear that the belt according to the invention allows an improvement in the torque transmissible by the belt and its stability. In fact, in use, the contact surface between the transverse and longitudinal teeth of the belt and the teeth of the pulley is large thanks to the shape of the teeth of the belt. This high contact area and the presence of cords improve the tensile modulus of the belt, so the transmissible torque may be controlled, as well as the levels of deformation of the belt, which reduces wear of the belt over time and therefore improves its service life. In addition, the longitudinal teeth guide the belt over the pulley, preventing it from moving laterally.

Another advantage is that, when the belt is mounted on a pulley of the assembly according to the invention, it allows the outer elements that may be inserted into the tooth recesses of the pulley, such as water, earth, mud or stones, to be removed.

1. A synchronous transmission belt comprising an elastomer-based body comprising a dorsal portion, a ventral portion and an assembly of tensile cords between the dorsal portion and the ventral portion, the ventral portion having, on the one hand, a plurality of transverse teeth, each transverse tooth having in cross-section a first profile with two inclined flanks converging towards each other in the direction of a summit of the transverse tooth, said flanks of the transverse tooth being connected by at least one rounded part, each transverse tooth having a tooth height H1, and, on the other hand, a plurality of longitudinal teeth, each longitudinal tooth extending between two transverse teeth substantially perpendicular to said transverse teeth and having in cross-section a second profile with two inclined flanks, converging towards each other in the direction of a summit of the longitudinal tooth, said flanks of the longitudinal tooth being connected by at least one rounded part, each longitudinal tooth having a tooth height H2, said non-zero tooth height H2 being less than or equal to the tooth height H1.

2. The belt according to claim 1, wherein the tooth height H2 of each longitudinal tooth is such that 0.4×H1≤H2≤0.8×H1.

3. The belt according to claim 1, wherein each transverse tooth has in cross-section a first trapezoidal profile with rounded angles.

4. The belt according to claim 3, wherein said first profile of each transverse tooth comprises two convex summit portions, said convex summit portions being located on either side of a summit portion, and two concave portions, said concave portions being located on either side of a base of the transverse tooth.

5. The belt according to claim 4, wherein each convex summit portion of said first profile has an approximate radius of curvature of between 0.6 mm and 1.4 mm, and each concave portion has a radius of curvature of between 0.6 mm and 1.4 mm.

6. The belt according to claim 1, wherein said second profile of each longitudinal tooth comprises two concave portions, said concave portions being located on either side of a base of said longitudinal tooth, and a tooth summit, said summit being convex.

7. The belt according to claim 6, wherein each concave portion of said second profile has a radius of curvature of between 0.8 mm and 1.6 mm, and said summit of the second profile has a radius of curvature of between 0.8 mm and 1.6 mm.

8. The belt according to claim 1, wherein said second profile of each longitudinal tooth is a trapezoidal profile with rounded angles.

9. The belt according to claim 1, comprising a coating arranged at the level of an external surface of the plurality of transverse and longitudinal teeth.

10. The belt according to claim 9, wherein the elastomer-based body of belt is made of a material chosen from an ethylene-alpha-olefin or a polyurethane, and the coating is a textile material or an elastomer thermoplastic film.

11. The belt according to claim 1, wherein each cord of the assembly of tensile cords is made of aramid, polyester, glass fiber or carbon fiber or a combination thereof.

12. An assembly comprising at least one pulley and a synchronous transmission belt according to claim 1, each pulley comprising:
two circumferential rows of toothing parallel to each other and configured to receive the tooth recesses of the plurality of transverse teeth of the belt, and
a circumferential groove, separating the two circumferential rows of toothing, configured to receive the plurality of longitudinal teeth of the belt.

13. The assembly according to claim 12, wherein each circumferential row of toothing comprises tooth recesses having a depth P1 greater than a height H1 of the transverse teeth of the belt.

14. The assembly according to claim 12, wherein the longitudinal groove has a depth P2 greater than a height H2 of the longitudinal teeth of the belt.

15. A method for manufacturing a belt according to claim 1, said method comprising the following steps:
forming a belt blank from belt materials around a cylindrical mandrel;
removing the blank from the mandrel;
inserting the blank inside a cylindrical mold comprising, on an internal cylindrical wall, a negative pattern of transverse and longitudinal teeth to be formed on a belt;
pressing said blank against said mold by means of an inflatable rubber bladder, and heating said mold so as to vulcanize the belt blank;
unmolding the vulcanized blank; and
cutting the vulcanized blank so as to form the belt.
